(19) United States
(12) Patent Application Publication
(10) Pub. No.: US 2011/0163961 A1
(43) Pub. Date: Jul. 7, 2011

(54) APPARATUS FOR ENTERING USER INPUTS INTO AN ELECTRONIC DEVICE

(76) Inventor: James David Smith, Chilwell (GB)

(21) Appl. No.: 12/933,952

(22) PCT Filed: Mar. 27, 2009
(86) PCT No.: PCT/GB2009/050300

§ 371 Date: Mar. 22, 2011

(30) Foreign Application Priority Data
Mar. 27, 2008 (GB) 0805478.5

(51) Int. Cl. G06F 3/02

(52) U.S. Cl. 345/168

(57) ABSTRACT

Electronic devices such as mobile telephones have the ability for a wide range of commands to be implemented via a number of keys. Because the number of keys is limited it is usually necessary to map more than one possible command to a particular key. For example, each command may be an instruction to a texting software application running on the mobile to insert a particular character into the text. Each key may be used to enter four characters. However, it is desirable to provide a capability to handle even greater number of characters per key in a convenient manner and this is achieved by providing different map levels where each level provides a set of characters to be “mapped” to the key. A command is provided at each level for the selection of another map level. Thus, by using this command, the key may be mapped to more characters in a very convenient manner.

### CROSS-REFERENCE TO RELATED APPLICATIONS

This application is the United States national phase under 35 U.S.C. §371 of PCT International Application No. PCT/GB2009/050300, filed on Mar. 27, 2009, and claiming priority to British Application No. 0805478.5, filed on Mar. 27, 2008. Both of those applications are incorporated by reference herein.

### BACKGROUND OF THE INVENTION

1. Field of the Invention

Embodiments relate to apparatus for entering user inputs into an electronic device particularly, but not exclusively, for inputting characters into a mobile telephone, but it is not limited to such an application. Embodiments also relate to methods for entering user inputs into a electronic device.

2. Background of the Art

A typical mobile telephone (hereinafter referred to as a mobile) has a key pad having ten keys for inputting the numbers “0” to “9” and also other keys such as “*” and “#”. These are used to enter a number to be dialled but may also be used in other applications requiring user input such as a texting application. In a texting application the keys are also used to enter the selection of characters when a text message is composed. Each key is allocated three or four characters and, by pressing a particular key, the characters are displayed for selection in a sequence. For example, key for number “3” may also be allocated for the selection of letters “DEF”. Thus when in text mode, pressing the key will result in the letters DEF being displayed in a sequence and, by pressing the key the appropriate number of times, the desired letter is selected.

It will be appreciated that if the key is not pressed in a prompt manner, a subsequent letter will not be selected or the sequence will have to be repeated. Where the sequences are long, for example, where an extended character set is supported, this can be very frustrating to a user. In an attempt to alleviate this, some keys are used to access the extended character set but this results in fewer keys being available for use.

### BRIEF SUMMARY OF THE INVENTION

The present invention arose in an attempt to provide a more efficient way of enabling a user to interact with an electronic device without using a lot of the available display space and for which no extra keys are essential.

According to one aspect, embodiments provide apparatus for entering user inputs into an electronic device, comprising; an input having a plurality of keys for enabling user input; a memory including a plurality of maps each allocating characters/commands to one of the keys, wherein each map has more than one level and each level has at least one command for enabling migration to another level; a processor coupled to the display device and responsive to a manner of actuation of each key to cause the display to display either a character in the current level corresponding to that manner of actuation of that key or a command in the current level corresponding to that manner of actuation of that key; wherein displaying the command results in migration to another level.

The keys may be actuated to display characters/commands of one map level and other characters/commands of one or more other map levels that may be accessed from the first map level. This enables an extended character set, for example, to be more easily supported and used.

By map level it is meant a logical level from which a certain set of characters/commands may be selected. A further map level will have a further set of characters/commands. The characters/commands in any level may be selected when the level is current.

By key it is meant any button, real or displayed, which may be actuated by being depressed or touched by a user.

The manner of actuation of a key may be one or more presses or touches of a key, or a pause between presses or touches of a key, or any combination thereof.

Embodiments may be implemented in a number of different types of electronic devices. These could include mobile telephones or other communications device, personal digital assistants, MP3 players or computer devices.

According to another aspect, embodiments provide a method for entering user inputs into an electronic device, comprising: providing a plurality of keys to enable user input; providing a plurality of maps each allocating characters/commands to one of the keys wherein each map has more than one level and each level has at least one command for enabling migration to another level; providing a display; actuating a key; responding to the manner of actuation of the key to display on the display either a character in the current level corresponding to that manner of actuation of that key or a command in that level corresponding to that manner of actuation of that key; wherein displaying a command results in migration to another level.

### BRIEF DESCRIPTION OF THE FIGURES

FIG. 1 shows in schematic block diagram form a mobile telephone in accordance with the invention;

FIG. 2 shows map levels in the mobile phone of FIG. 1;

FIG. 3 shows the way in which the map levels of FIG. 2 are navigated through and selected; and

FIG. 4 is a further embodiment in which migration/navigation can occur through the various levels.

### DETAILED DESCRIPTION OF THE INVENTION

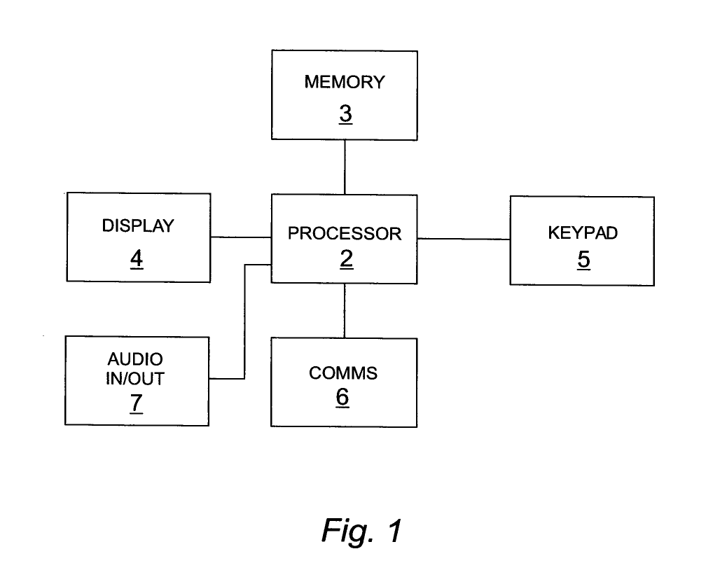

An embodiment will now be described, by way of example, with reference to the figures. As is shown in FIG. 1, a mobile 1 comprises a processor 2, a memory 3, a display 4, a keypad 5, a communications section 6 and an audio input and output section 7. The processor 2 is programmed to provide the various functionality required by the mobile 1 and it utilises instructions or program located in the memory 3 to do this. The display 4 is a liquid crystal display coupled by a data and control bus to the processor 2. The processor 2 is thus able to instruct the display 4 to displays various characters, including, but not limited to, letters, numbers and symbols, and other items. The keypad 5 comprises a set of buttons, actuated by being pressed, providing alpha and numeric entry. The keypad 5 is read by the processor 2 at regular intervals in order to register any key being pressed.

The communications section 6 enables calls to be established to a network serving the mobile 1. It operates in accordance with a GSM standard in accordance with well known principles. Other communications standards may be used as appropriate. Whilst in this embodiment the functionality for communications is shown as a discrete block it may alternatively be provided by the processor 2.

The audio input output section 7 uses a microphone to pick up a user's speech; this is then digitised and encoded by the processor 2 before being passed to the communications section 6. The audio input output section 7 is also provided with a speaker. The speaker is fed decoded speech from the processor 2 which is delivered by the communications section 6 as a result of an incoming communication.

The memory 3 includes maps allocating characters/commands to the keys to the keypad 5. When a key is actuated a memory table of the maps is accessed. The map for each key has at least one level and each level has at least one character and at least one command. Each character/command in each level corresponds to a manner of actuation of the corresponding key.

The processor 2 is responsive to the manner of actuation of each key to cause the display 4 to display the corresponding character or command.

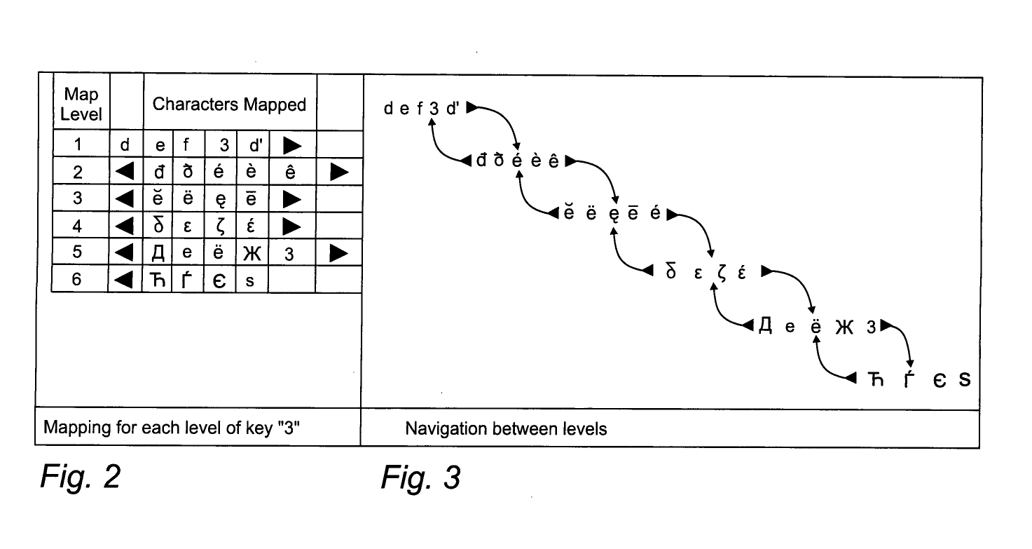

FIG. 2 shows the map table for the key for the number 3. It includes six levels 1 to 6. The first level 1 has a sequence of five characters: “d”, “e”, “f”, “3” and “d”. At the end of the sequence is a command, a horizontal rightward pointing arrow, which is a migration command. Actuating the key in a manner corresponding to the command, will lead to the display 4 displaying the horizontal arrow. Selection of the arrow command will lead to migration to the next level. It will be seen that the next level 2 includes, as a first command in the character/command sequence, a horizontal leftward pointing arrow. Actuating the key in a manner to select this arrow will result in the migration back to the level below, which in this case is level 1. At the end of the level sequence is another arrow command, selection of which will result in migration to the next level, level 3.

FIG. 3 shows in schematic form the way in which the various levels are accessed and displayed; in other words, their hierarchy. Each key has a current level which may be the lowest level or the last selected level.

Pressing the key corresponding to the map once causes the first character in the current map level to be displayed on the display 4. Pressing the same key again within a predetermined time moves the selection point to the next character/command in the map level (in a cyclic manner), causing that character/command to be displayed on the display 4. Each successive press of the key within the predetermined time moves the selection point to the next successive character/command in the map level sequence. Pausing on a character/command, without further presses, results in that character/command being selected. If a command is selected, a migration to another map level occurs.

It will be appreciated that the manner of the actuation of the keys, the way in which the characters/commands are selected, may be varied. For some embodiments the key may be pressed with a certain rapidity and a pause followed by a further press may result in a selection. A training sequence may be undertaken when the mobile is first used by a user to enter the preferred selection settings. The way in which the user uses the mobile may be used over the longer term to further refine the response.

In yet further embodiments in order to switch or migrate from one level to another, a separate key may be pressed.

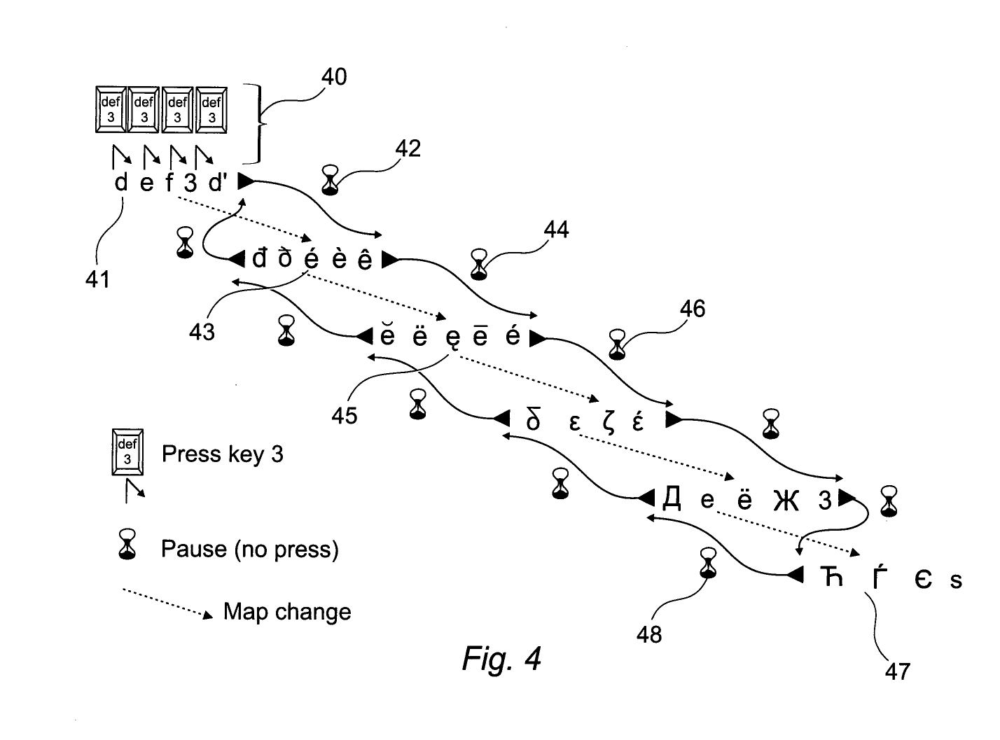

FIG. 4 shows another embodiment of the invention. In this embodiment, a navigation arrow may be selected and then the next map level of characters will be displayed. The user may then press to access those characters or if there is a pause of sufficient length between pressing the next map level will be displayed and so on. The first stage of the operation 40 involves the access of characters in map level 1, having characters 42, which are allocated to the numeral 3 key. Thus combinations of key presses will result in the selection of the characters “d”, “e”, T, “3”, “d” or the navigation arrow.

If the navigation arrow is selected or if there is a pause (no key press), as denoted by the egg timing signal 42, the next map level, level 2, having characters 43 will be displayed. If the user presses the key in a prompt manner the characters available in that level may be cycled through. However, if the key is not pressed, after a pause 44 the next map level, level 3, having characters 45, will be displayed. Again this level may be accessed by a key press and the characters selected or, if another pause 46 elapses, then the next level displayed.

When the final level displaying characters 47 is reached then a pause 48 will result in a dropping down to the previous level. This may be repeated until the first level 41 is reached. Thus, in summary in this embodiment navigation may be achieved by selection of navigation symbol by a key press or by merely pausing in the key pressing operation.

1. An apparatus for entering user inputs into an electronic device comprising: an input device having a plurality of keys for enabling user input; a memory including a plurality of maps each allocating at least one character and at least one command to one key, wherein each map has a plurality of levels and each level has at least one command for enabling migration to another level; a processor coupled to a display and responsive to a manner of actuation of each key to cause the display to display either the character in a current level corresponding to that manner of actuation of that key or a command in that level corresponding to that manner of actuation of that key, wherein displaying the command results in migration to another level.

2. The apparatus of claim 1, wherein each key comprises a member of the group consisting of a real button, and a real or displayed button.

3. The apparatus of claim 1, wherein each key is actuated by a member of the group consisting of being pressed and being touched.

4. The apparatus of claim 3, wherein the manner of actuation of a key comprises one or more members of the group consisting of presses of the key touches of the key, a pause between presses of the key, and a pause between touches of the key.

5. The apparatus of claim 3 wherein a pause in actuation of a key results in a migration between map levels.

6. The apparatus of claim 1 wherein the current map level is selected from the group consisting of the lowest map level and the last selected map level.

7. A communications device Comprising the apparatus of claim 1.

8. A method for entering user inputs to an electronic device comprising: providing a plurality of input keys to enable user input; providing a plurality of maps each allocating at least one character and at least one command to at least some of the keys, wherein each map has more than one level and each level has at least one command for enabling migration to another level; providing a display; actuating a key; responding to a manner of actuation of the key to display either the character in a level corresponding to that manner of actuation of that key or a command in that level corresponding to that manner of actuation of that key; wherein displaying a command results in migration to another level.

9. The method of claim 8 wherein each key is actuated by a member of the group consisting of being depressed and being touched.

10. The method of claim 9, wherein the manner of actuation of a key is selected from the group consisting of one or more presses or touches of the key, a pause between presses or touches of the key, and combinations thereof.

11. The method of claim 9, wherein a pause between actuations of a key results in a migration between map levels.

12. A method for entering user inputs to an electronic device comprising:
actuating at least one key, wherein said key is allocated at least one character and at least one command by a plurality of maps, wherein each map has more than one level and each level has at least one command for migrating to another level;
responding to a manner of actuation of said at least one key by displaying either the character in that level corresponding to the manner of actuation or a command in that level corresponding to that manner of actuation; and
migrating to another map level if a command is displayed.
